(19) United States
(12) Patent Application Publication
(10) Pub. No.: US 2004/0007690 A1
(43) Pub. Date: Jan. 15, 2004

(54) Methods for polishing fiber optic connectors

(75) Inventors: Gary W. Snider, Aurora, IL (US); J. Scott Steckenrider, Plainfield, IL (US); Steven K. Grumbine, Aurora, IL (US)

Correspondence Address: Phyllis Turner-Brim, Cabot Microelectronics Corp., 8701 Commons Drive, Aurora, IL, 60504, US

(73) Assignee: Cabot Microelectronics Corp.

(21) Appl. No.: 10/194,390

(22) Filed: Jul. 12, 2002

(51) Int. Cl. C09K 13/00

(52) U.S. Cl. 252/79.1

(57) ABSTRACT

Methods for controllably polishing fiber optic connectors that include a ferrule enclosing single or multiple optical fibers by manipulating the ingredients of the polishing composition to control the relative polishing rates of the ferrule material and the optical fiber material to obtain the desired connector end face surface finish and geometry.

### BACKGROUND OF THE INVENTION

(1) Field of the Invention

This invention includes methods for controllably polishing substrates including an optical material and a non-optical material wherein the dissimilar materials are polished at controlled rates. The methods of this invention are especially useful for polishing fiber optic connectors that include a ferrule material enclosing single or multiple optical fibers by manipulating the ingredients of the polishing composition to control the relative polishing rates of the ferrule material and the optical fiber material in order to obtain the desired connector surface finish and geometry.

(2) Description of the Art

Optical fibers are generally connected to one another by securely bonding the optical fibers along the axes of cylindrical holes in fiber-holding blocks called ferrules and thereafter aligning two ferrules in a sleeve in a face-to-face relationship. Stable performance is obtained by polishing the end faces of the ferrules into planar convex spherical surfaces with the optical fiber on the vertices to allow for alignment with an opposing optical fiber.

During end face polishing, the polishing progresses differently on the fiber and ferrule because of differences in the polishing properties between the materials. Specifically, the polishing generally progresses faster in the area of the optical fiber, resulting in a recess in the fiber end. The advent of optical systems of larger capacities and higher speeds has resulted in a need to eliminate such recesses or, in some cases, to form connectors with fibers that protrude from the ferrule.

Current ferrule polishing methods use abrasive pads and pastes that suffer from several problems including fluctuation in polishing performance and result in retraction of the fiber from the end face of a ceramic ferrule and/or poor end face surface quality. This has created a problem in that the step formed by the fiber can not be controlled and, therefore, it is difficult to provide a fiber optic connector having stable, defect free connection performance. In addition polished optical fiber surfaces are often distorted with a large step being formed on the end of an optical fiber ferrule because of the retraction of the fiber. Further, existing polishing methods require frequent pad change and connector polishing rework, resulting in high total costs of ownership. As a result, currently available fiber optic finishing methods are unable to produce polishing optical connector ferrules with stable and ultra-high quality at a low cost. There is a need, therefore for new and improved methods for polishing the end face of fiber optic connector to produce a high quality connector, reproducibly and at a low cost.

### SUMMARY OF THE INVENTION

One aspect of this invention are methods for polishing a substrate including an optical material portion and a non-optical material portion by the steps comprising: (a) applying a polishing composition to the substrate; and (b) polishing the substrate with a polishing substrate until at least a portion the optical material portion is removed from the substrate and at least a portion of the non-optical material portion is removed from the substrate.

Another aspect of this invention are methods for polishing an end face of an optical fiber connector that includes an optical material portion and a ferrule material portion by the steps comprising: (a) applying a polishing composition to the connector end-face; and (b) polishing the optical material portion and the ferrule material portion of the connector simultaneously with a polishing substrate until at least a portion the optical material portion and at least a portion of the ferrule material portion are removed from the end-face wherein the optical material portion and ferrule material portion are removed by a combination of chemical and mechanical polishing.

Still another aspect of this invention are methods for preparing a polishing composition for use in finishing the end face of a fiber optic connector wherein the connector includes a ferrule enclosing at least one optical fiber having a core surrounded by a cladding material. The methods include, in no particular order the steps of identifying the ferrule material; identifying the optical fiber material; identifying the desired connector end face geometry; and selecting one or more ingredients for a polishing composition that will polish the ferrule material and the fiber optic material and rates relative to each other that will produce the desired connector end face geometry.

### DESCRIPTION OF THE FIGURES

FIGS. 1A and 1B are side and end views of end face 5 of fiber optic connector 10. The fiber optic connector end face shown includes a ferrule 12 surrounding a single optical fiber 14 which includes a core 16 and a cladding 18;

FIG. 2 is a side cut away view of a fiber optic connector including a ferrule 12 that includes a plurality of optical fibers 14;

FIG. 3 is an end view of a fiber optic ribbon connector that can be finished by the methods of this invention;

FIG. 4 is a side view of a pig-tail optical fiber connector;

FIGS. 5A, 5B, and 5C depict side cross section views of optical fiber connectors before they are finished by methods of this invention; and

FIG. 5D is a side cross section view of a fiber optic connector that has been finished by methods of this invention.

### DESCRIPTION OF THE CURRENT EMBODIMENT

The present invention is directed to methods for controllably finishing the surface of a substrate including an optical material portion and a non-optical material portion. More particularly, the present invention is directed to method for controllably finishing the end faces of optical connectors to provide the required connector end face geometry and surface finish. The methods of this invention are able to reproducibly finish the surfaces of substrates such as optical connector end faces at low cost and with few defects. Another aspect of this invention are methods for tailoring polishing compositions for use in polishing substrate surfaces that include an optical material portion and a non-optical material portion.

The term “ferrule” is used herein in a manner that is broader than the manner in which the term is used by persons in the art. The term “ferrule” refers to a material that surrounds the end of an optical fiber that protects the optical fiber and that positions the end of an optical fiber so it can be positioned for connection to other optical fiber connectors and devices. The term “ferrule” encompasses materials that may be permanently associated with the optical fiber end and to materials that can be removed partially or totally from the first optical fiber end prior to, during, or following the association of a first optical fiber end face with a second optical fiber end face or optical device.

The term “dissimilar materials” is used herein to refer to two or more materials that differ in their chemical, mechanical, or physical properties or reactivity towards a polishing composition ingredient. The term “dissimilar materials” can encompass two materials having the same chemical composition but that differ in their physical properties as a result of being produced by different manufacturing or treatment methods. An example of such a dissimilar material would be a glass that is treated at different thermal conditions which cause the resulting glass materials to differ in crystallinity.

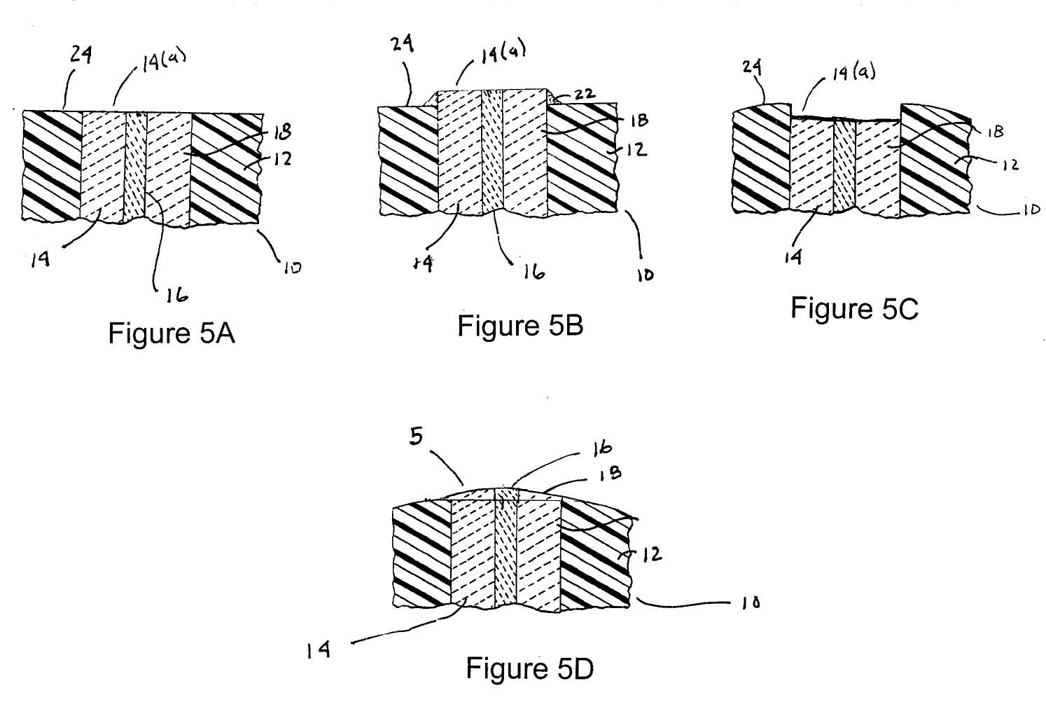

The processes and methods of this invention are directed towards polishing the surfaces a wide variety of substrates that include an optical material portion and a non-optical material portion. A preferred substrate surface is the end face of fiber optic connectors that include an optical fiber material and a ferrule material. It is preferred that the optical connector end faces are finished or polished such that the optical fiber material, depending upon connector application, is or are even with or protrude from the ferrule material. By “protrude” we mean the fiber (and particularly the fiber core) extends beyond the interpolated surface of the ferrule end face as shown, for example in FIG. 5D.

The methods of this invention are useful for polishing or finishing the surfaces of a variety of substrates that include an optical material portion and a non-optical material portion such as optical fiber connector end faces, photonic light circuits, optical fibers and so forth. However, the methods of this invention will be described in the context of finishing the end faces of all types of fiber optic connectors. This description is not intended to limit the scope of the methods of this invention in any manner to the specific applications disclosed below.

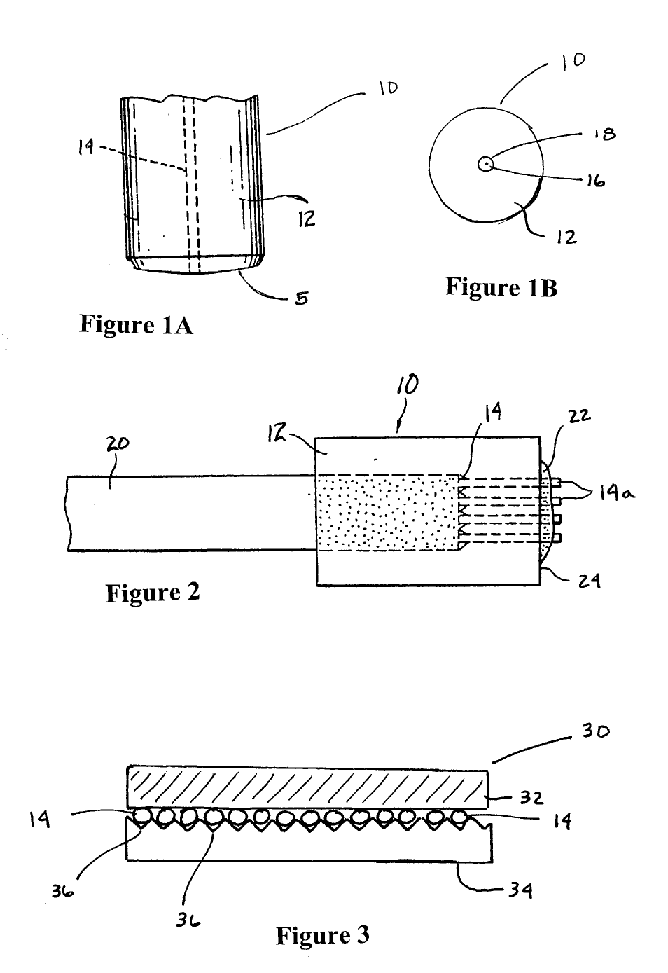

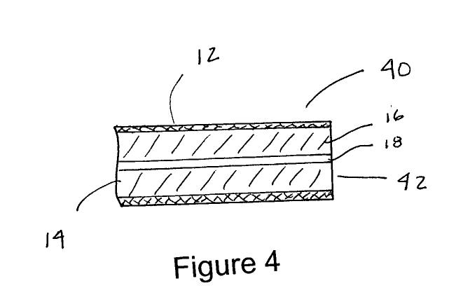

Non-limiting examples of fiber optic connectors that may be finished by methods and compositions of this invention include single fiber connectors (shown in FIGS. 1A and 1B), multi fiber connectors (shown in FIG. 2), fiber array connectors (shown in FIG. 3) and pig tail connectors (shown in FIG. 4). Each of the connectors include a ferrule material that partially or totally surrounds an optical fiber. The ferrule material performs a variety of functions, the primary functions being protecting the optical fiber from damage and securing the optical fiber in a known position that allows the optical fiber end to be associated with an adjacent optical device or optical fiber connector. The ferrule material may be permanent or it may be a material that is partially or fully removable from the optical fiber. The ferrule material may be selected from inorganic and organic materials. The organic materials may be polymers such as thermoset or thermoplastic polymers as well as other homogenous or heterogeneous polymers. Examples of inorganic materials include, but are not limited to metallic, ceramic or glass materials or combinations thereof such as ZrO₂, silicon, stainless steel, copper as well as combinations thereof.

Single optical fiber connectors that can be finished by the methods of this invention are shown in FIGS. 1A and 1B. Connector 10 shown in FIGS. 1A and 1B include a ferrule 12 surrounding a single optical fiber 14. Optical fiber 14 includes a core 16 surrounded by cladding 13. Connector 10 also includes an end face 5 that is finished by the methods of this invention.

Connector 10, shown in FIG. 2, includes a cable 20 that enters ferrule 12 and terminates in a plurality of optical fibers 14. The ends 14A of optical fibers 14 may be held in place by an adhesive material 22. Each optical fiber 14 includes an exposed end 14A that may be flush with, that may protrude from, or that may be embedded in ferrule 12. Ferrule 12 further includes an exposed surface 24.

A ribbon connector 30 is shown in FIG. 3. Ribbon connector 30 includes a top 32 and a bottom 34 with one or more optical fibers 14 sandwiched in between top 32 and bottom 34. Top 32 and/or bottom 34 may include optional v-grooves 36 for securing a plurality of optical fibers 14 in a parallel orientation. Optical fibers 14 may be held in place between top 32 and bottom 34 using adhesive or some other bonding material. It is very difficult to align the ends of optical fibers 14 such that they have the same geometry with respect to the top 32 or bottom 34 of ribbon connector 30. Therefore, a finishing step is required in order to adjust the geometry of the optical fiber ends so that they can be easily associated with a complementary connector.

Ribbon connector top 32 is typically manufactured from glass or Pyrex while ribbon connector bottom 34 may be manufactured from a dissimilar material such as silicon. The materials used to manufacture top 32 and connector bottom 34 may be different combinations of glass, pyrex, silicon and other known ferrule materials. An example of optical fiber ribbon connectors is disclosed in U.S. Pat. No. 5,689,559 the specification of which is incorporated herein by reference.

FIG. 4 is a side cross section view of a fiber pig-tail connector 40 that can be finished by the method of this invention. The fiber pig-tail is typically used for associating an optical fiber with a laser or some other optical device. Fiber pig-tail 40 includes an optical fiber 14 and a ferrule 12. The ferrule material will typically be selected from a weldable material such as copper or stainless steel. The fiber pig-tail includes an end face 42. Fiber pig-tail 40 is associated with an optical device by orientating an optical device such as a laser with the end face 42 of optical fiber 14 and thereafter securing the connector to a foundation by, for example welding.

The components included in the connectors shown in FIGS. 1A, 1B, 2, 3 and 4 are manufactured from standard materials that are within the knowledge of one of ordinary skill in the art. Optical fiber 14 will typically be manufactured from an optical glass or polymeric material such as doped and undoped glass, polymethylmethacrylate, polystyrene, perfluorinated polymers, and the like. Optical fiber core 16 will typically have a diameter ranging from about 1 to about 60 microns or more while the cladding material will naturally vary in diameter from about 25 to 130 microns or more although some optical fibers have diameters in excess of 130 microns. The core and cladding material may be manufactured from materials that are well known to one of ordinary skill in the art including, but not limited to glass or transparent polymer or resin materials. Ferrule 12 is useful for positioning and securing optical fiber 14 in and is typically manufactured from materials including, but not limited to glass, polymeric materials, ceramic materials and the like. A common ferrule material is ZrO₂.

FIGS. 5A, 5B, 5C and 5D depict end faces 5 of a connector 10 including optical fiber 14 and ferrule 12 prior to end face finishing. Optical fiber end 14A can be flush with ferrule exposed surface 24 as shown in FIG. 5A, optical fiber end 14(a) can protrude from ferrule 12 as shown in FIG. 5B or according to FIG. 5C, optical fiber end 14(a) can be recessed in ferrule 12. Regardless of the orientation of optical fiber 14(a) with respect to ferrule end 12(a), it is an aspect of this invention to provide a method for finishing the ferrule end faces to obtain any ferrule/optical fiber orientation and preferably the ferrule/optical fiber orientation shown in FIG. 5D in which optical fiber 14 protrudes from ferrule 12. The optical fiber end face geometry shown in FIG. 5D is most preferred from both single and multiple fiber connectors.

The methods of this invention are useful for polishing optical fiber connectors wherein the optical fiber 12 and ferrule 14 are made of dissimilar materials. The methods of this invention comprise finishing end faces 5 of optical fiber connectors using chemical polishing methods, mechanical polishing methods, or both chemical and mechanical polishing methods. In particular, an important aspect of this invention is identifying the dissimilar ferrule and optical fiber materials that must be polished and selecting one or more polishing composition ingredients that will polish the different materials in a manner that will provide the desired ferrule end face geometry and surface finish. Often, connector ferrule and optical fiber materials will have different hardness's. Abrasives will typically polish the softer materials more quickly than the harder materials thereby causing recessing of the component manufactured of the softer material in relation to the component manufactured of the harder material. It has been discovered that chemical mechanical polishing techniques can be applied to finish the end faces of optical fiber ferrules. In particular, ingredients that are used in chemical mechanical planarization of integrated circuits can be selected and incorporated into a polishing composition that is useful for polishing any ferrule/optical fiber dissimilar material combination to any desired end face geometry. More specifically compositions can be manufactured that remove the ferrule material and leave the fiber optic material essentially intact or conversely that polish the optical fiber material and leave the ferrule material intact. Alternatively polishing compositions can be formed that are capable of polishing the ferrule material at a faster or slower rate than the optical fiber material. The selection of the useful polishing composition ingredient(s) will ultimately depend upon variables such as the materials being finished, the desired end face geometry, polishing conditions and so forth.

An important aspect of the process of this invention is the selection of the appropriate polishing composition ingredient(s). The polishing compositions useful in the process of this invention will typically include at least one and possibly two or more of the following ingredients: (1) a soluble chemical; (2) an insoluble chemical; and (3) a fluid carrier.

Soluble Chemicals

The soluble chemical may be any chemical that is soluble in one or more of the fluid carriers identified below. A non-limiting list of soluble chemicals that can be incorporated into polishing compositions for use in polishing fiber optic connector end faces include oxidizing agents, acids, film forming agents, bases, etch inhibitors, catalysts, amino compounds, ammonium compounds, hydroxylamines, polishing accelerators, stopping compounds and combinations thereof.

Oxidizing Agents

Oxidizing agents are useful, when incorporated into polishing compositions, for oxidizing materials such as polymer and metal ferrules. The oxidizing agents used may be one or more inorganic or organic per-compounds. A per-compound as defined by Hawley's Condensed Chemical Dictionary is a compound containing at least one peroxy group (—O—O—) or a compound containing an element in its highest oxidation state. Examples of compounds containing at least one peroxy group include but are not limited to hydrogen peroxide and its adducts such as urea hydrogen peroxide and percarbonates, organic peroxides such as benzyl peroxide, peracetic acid, and di-t-butyl peroxide, monopersulfates (SO₅⁼), dipersulfates (S₂O₈⁼), and sodium peroxide.

Examples of other useful oxidizing agents include compounds containing an element in its highest oxidation state including but not limited to periodic acid, periodate salts, perbromic acid, perbromate salts, perchloric acid, perchloric salts, perboric acid, and perborate salts and permanganates. Examples of non-per compounds that meet the electrochemical potential requirements for oxidizing agents include but are not limited to bromates, chlorates, chromates, iodates, iodic acid, and cerium (IV) compounds such as ammonium cerium nitrate, ferric compounds, such as ferric nitrate and combination of compounds. Especially preferred oxidizing agents include hydrogen peroxide, iodates and ferric compounds.

Organic Acids

A wide range of conventional organic acids are useful in polishing compositions to modify polishing rates. The term “organic acids” as used herein refers to organic acids, and their salts, and combinations thereof. Examples of useful classes of organic acids include, but are not limited to monofunctional acids, di-functional acids, hydroxyl/carboxylate acids, chelating, non-chelating acids, and their salts. Many organic acids are chemically active towards particular materials and depending upon the material being polished, can enhance or stop polishing by absorbing onto the surface being polished. Organic acids may be selected from the group of acetic acid, adipic acid, butyric acid, capric acid, caproic acid, caprylic acid, citric acid, glutaric acid, glycolic acid, formic acid, fumaric acid, lactic acid, lauric acid, malic acid, maleic acid, malonic acid, myristic acid, oxalic acid, palmitic acid, phthalic acid, propionic acid, pyruvic acid, stearic acid, succinic acid, tartaric acid, valeric acid and derivatives, including salts thereof. The organic acid may also be selected from polyacids such as polyacrylate acid, polymethacrylate acid, polysulfonic acid and polyphosphonic acid. The organic acid or salt should be present individually or in combination with other organic acids or salts in a fiber optic connector polishing composition in an amount sufficient to promote or inhibit the polishing rates of a first dissimilar material in comparison to a second dissimilar material. As such, the organic acid is typically present in the slurry from about 0.05% to 15% by weight and more preferably in an amount ranging from about 0.2 to about 2.0 wt %.

Catalysts

The polishing compositions used in this invention may include one or more optional catalysts. The catalyst or catalysts chosen may be homogeneous or heterogeneous, and they may be metallic, non-metallic, or a combination thereof. One class of catalysts that operate in conjunction with an oxidizing agent are metal compounds that have multiple oxidation states, such as but not limited to Ag, Co, Cr, Cu, Fe, Mo, Mn, Nb, Ni, Os, Pd, Ru, Sn, Ti and V. The term “multiple oxidation states” refers to an atom and/or compound that has a valence number that is capable of being augmented as the result of a loss of one or more negative charges in the form of electrons. Preferred metal catalysts are compounds of Ag, Cu and Fe and mixtures thereof. Especially preferred are iron catalysts such as but not limited to inorganic salts of iron, such as iron (II or III) nitrate, iron (II or III) sulfate, iron (II or III) halides, including fluorides, chlorides, bromides, and iodides, as well as perchlorates, perbromates and periodates, and ferric organic iron (II or III) compounds such as but not limited to acetates, acetylacetonates, citrates, gluconates, oxalates, phthalates, and succinates, and mixtures thereof.

Etching Inhibitors

Polishing compositions used in the methods of this invention may include at least one etching inhibitor. Etch inhibitors are used in conjunction with chemical components that accelerate material removal such as complexing agents, polishing accelerators and oxidizing agents to slow down and/or inhibit the conversion of a solid inorganic, polymeric or metallic material into soluble compounds while at the same time allowing the polishing composition to convert the solid material being polished into a soft film that can be evenly removed by abrasion. Classes of compositions that are useful etch inhibitors include compounds having nitrogen containing functional groups such as nitrogen containing heteroycles, alkyl ammonium ions, amino alkyls, amino acids.

Useful amino alkyl inhibitors include, for example, aminopropylsilanol, aminopropylsiloxane, dodecylamine, mixtures thereof, and synthetic and naturally occurring amino acids including, for example, lysine, tyrosine, glutamine, glutamic acid, glycine, cystine, serine and glycine.

Examples of useful etching inhibitors that include nitrogen containing heterocycle functional groups include 2,3,5-trimethylpyrazine, 2-ethyl-3,5-dimethylpyrazine, quinoxaline, acetyl pyrrole, pyridazine, histidine, pyrazine, isole compounds such as benzimidazole, and mixtures thereof.

Examples of etching inhibitors that include a nitrogen containing functional group and at least one functional group selected from thiol or sulfide functional groups include glutathione (reduced), cysteine, 2-mercapato benzimidazole, cystine, thiophene, mercapato pyridine N-oxide, thiamine hydrochloride, tetraethyl thiuram disulfide, 2,5-dimercapto-1,3-thiadiazole and mixtures thereof.

Amino and Ammonium Compounds

Another class of polishing composition ingredients are organic amino and ammonium compounds. Organic amino and ammonium compounds absorb on the surface of some materials and inhibit removal of the material while on others, they accelerate the material polishing rate. The classification of compounds as amino or ammonium compounds will generally depend on the solution pH. Examples of useful organic amino compounds include, but are not limited to, alkylamines, alcohol amines, amino acids, urea, derivatives of urea, and mixtures thereof. Preferred organic amino compounds are long chain alkylamines and alcoholamines. The term “long chain alkylamines” refers to alkylamines having from 7 to 18 or more carbon atoms including, for example, nonylamine and dodecylamine. Examples of useful alcoholamines include, but are not limited to monoethanolamine, and triethanolamine. Examples of useful derivatives of urea include, but are not limited to bi-urea. An examples of an organic amino compound is the long chain alklyamine, dodecylamine. The long chain alkylamines may be substituted with a variety of substituents including, but not limited to, halogen, alcohols, aromatic substituents and so forth.

Examples of useful alcoholamines include ethanol amines, propanol amines, primary alcoholamines, secondary alcoholamines, tertiary alcoholamines and so forth.

Examples of useful tertiary alcoholamines include triethanol amine, dialkylethanol amine, alkyl diethanol amine, 2-dimethylamino-2-methyl-1-propanol, and 2-amino-2-methyl-1-propanol.

Amines can be protinated at certain pH's to form alkyl ammonium ions. Amines typically will be protinated at a pH that is equal to or less than the amine pKa-1. Examples of useful alkyl ammonium ion functional groups include, but are not limited to, monoquat isies (isostearylethylimididonium), cetyltrimethyl ammonium hydroxide, alkaterge E (2-heptadecenyl-4-ethyl-2 oxazoline 4-methanol), aliquat 336 (tricaprylmethyl ammonium chloride), nuospet 101 (4,4 dimethyloxazolidine), tetrabutylammonium hydroxide, tetramethylammonium hydroxide and mixtures thereof. Generally alkylammonium compounds will have four or more and preferably seven or more carbon atoms.

Film Forming Agents

Yet another optional polishing composition ingredient are film forming agents. Film forming agents may be any compound or mixtures of compounds that are capable of facilitating the formation of a passivation layer of oxides or dissolution inhibiting layers on the surface of a layer being polished. Passivation of the substrate surface layer is important to prevent wet etching of the substrate surface.

One or more film forming may be present in the polishing compositions used in this invention in an amount that is sufficient to produce measurable improvements in slurry stability. Polymers and surfactants are useful classes of film forming agents. Useful surfactants can be anionic, cationic, nonionic, or amphoteric surfactants or a combination of two or more surfactants can be employed. Non-limiting examples of useful surfactants include but are not limited to phosphonic acids such as aminotri(methylenephosphonic) acid, 1-hydroxyethylidene-4-diphosphonic acid, hexamethylenediaminetetramethylene phosphonic acid, and diethylenetetramine pentamethylenephosphonic acid. Non-limiting examples of useful polymer film forming agents include, but are not limited to polyacrylate, polymethacrylate, polyacrylamide, polyethylenimine and combinations thereof.

Hydroxylamines

The methods of this invention may use polishing compositions including one or more hydroxylamines. The term hydroxylamine additive as used herein refers to hydroxylamine (NR₂OH) where R is H, or a carbon based moiety such as alkyl, alkene, aryl cycloalkyl and so forth, derivatives of hydroxylamine, and hydroxylamine salts including, for example, nitrate salts, sulfate salts, phosphate salts and mixtures thereof. U.S. Pat. No. 5,735,963, the specification of which is incorporated herein by reference, discloses hydroxylamine derivatives and salts thereof that are useful in the chemical mechanical polishing compositions of this invention. Preferred hydroxylamine additives include hydroxylamine, hydroxylamine nitrate, hydroxylamine sulfate, hydroxylamine phosphate and mixtures thereof. Most preferred hydroxylamine additives are hydroxylamine, hydroxylamine nitrate, and mixtures thereof.

Polishing Accelerators

The methods of this invention may use polishing compositions including polishing accelerators that etch or form a passivation layer on glass, polymer or metal features. If a passivation layer is formed, it becomes useful to be able to disturb the passivation layer with a polishing accelerator in order to more easily remove material from the connector end face with or without an abrasive. Polishing accelerators that are particularly useful for glass materials are salts. Useful salts will include the in situ combination of any metal and acid or the combination of any acid and base. Preferred salt cations include NR₄, Li, Na, Mg, K, Ca., Al, Rb, and Cs where R₄ is H, alkyl, Ce or Al. Preferred salt anions include NO₃, S04, halide, and PO₄. Polishing accelerators that are particularly useful in polymer polishing are salts that are strong nucleophiles including chloride, cyanide, alkyl sulfide ammonia, primary amines, fluoride ions alkali metals or earth metals. Most preferred salts include fluoride, cerium NR₄ and/or aluminum.

Other useful additives that disturb passivation layers and improve removal rates include alpha-amino acids having the formula H₂N—CR₁R₂COOH, wherein R₁ and R₂ are not both hydrogen and wherein R₁ and R₂ are each individually selected from the group of hydrogen, and cyclic, branched and straight chain moieties having from 1 to 8 carbon atoms that are unsubstituted or substituted with one or more substituents selected from nitrogen containing substituents, oxygen containing substituents and sulfur containing substituents including but not limited to —COOH, —CONH₂, —NH₂, —S—, —OH, thiol, and mixtures thereof. Useful Alpha-amino acid may be selected from the group consisting of alanine, arginine, aspargine, aspartic acid, cystine, glutamine, glutamic acid, histidine, isoleucine, lucine, lysine, methionine, phenylalanine, serine, thrieonene, tryptophan, tyrosine, valine, and mixtures thereof. The polishing accelerators will typically be present in compositions useful in the methods of this invention in an amount ranging from about 0.01 to about 3.0 wt % and preferably from about 0.2 to 1.0 wt %.

Stopping Compounds

The method of this invention may use one or more stopping compounds. Stopping compounds interact with the layer being polished and essentially stop the polishing action of the polishing composition. Stopping compounds may be any compound capable of absorbing onto the end face materials being finished thereby inhibiting their removal. Some examples of stopping compounds include cationically charged nitrogen containing compounds. By “cationically charged” it is meant that the stopping compound is in cationic form at the operating pH of the CMP composition or slurry. Another class of useful stopping compounds are nitrogen containing stopping compounds such as primary, secondary, tertiary and quartenary amines, simple, oligomeric, polymeric amines, imines, amides and imides. A more preferred class of nitrogen containing stopping compounds include polyethylenimines having molecular weights ranging from about 200 to over a million; N₄-amine (N,N′-bis-[3-aminopropyl]ethylene diamine), 4,7,10-trioxitridecane-1,13-diamine, 3,3-dimethyl-4,4-diaminodicyclohexylmethane, 2-phenylethylamine, polyetheramines, etheramines, N,N-dimethyldipropylenetriamine, 3-[2-methoxyethoxy] propylamine, dimethylaminopropylamine, 1,4-bis(3-amino propyl) piperazine polypyriolidones, polyacrylamides, tetra alkylammonium containing polymer and mixtures thereof. One of the novel aspects of this invention is a proper selection and use of one or more stopping compounds in polishing compositions to dial in enhanced or reduced removal rates of one dissimilar material such as the ferrule or optical fiber material relative to the other second dissimilar material in an optical fiber connector polishing process.

General Additives

Other well known polishing additives may be incorporated into composition useful in the methods of this invention. One class of optional additives are inorganic acids and/or salts thereof which may be added to the polishing slurry to further improve or enhance the polishing rate of particular materials. Useful inorganic additives include sulfuric acid, phosphoric acid, nitric acid, sodium hydroxide, cerium hydroxide, ammonium hydroxide and so forth.

Additives may also be included in the compositions that are selected to reduce surface defectivity and/or enhance the cleanability of the polished connectors. For example, additives may be added to the polishing compositions that interact with a solid chemical component such as an abrasive to reduce the particle roughness and thereby improve surface defectivity. Alternatively, soluble chemical components such as surfactants, film forming agents or stabilizers that promote the disperseability of solid chemical components in a polishing composition are useful to promote the cleanability of the polishing composition. The term “cleanability” refers to the ability of the polishing composition to be removed from the connector surface that is being finished and/or the ability of the polishing compositions to be removed from the machines that are used to controllably finish the end face of the fiber optic connectors. Ingredients that promote cleanability can be added as a soluble chemical into the polishing composition or they may be incorporated into a solid abrasive particle to form an insoluble chemical component.

Polishing composition ingredients that are included to promote cleanability may have little or no impact on the ability of the composition to polish the fiber optic end face. In other words, the ingredients can be added solely to promote cleanability and without impacting the end face polishing properties of the composition.

Insoluble Chemical Components

The insoluble chemical components may be any component that is essentially insoluble in one or more of the fluid carriers identified below. The insoluble chemical component is intended to remain insoluble in the compositions used to finish fiber optic end faces by the methods of this invention. The insoluble chemical components may be a homogenous material or a heterogeneous material. The insoluble chemical components will be present in the compositions of this invention in an amount sufficient to polish the dissimilar connector materials in the desired manner. The insoluble chemical component will typically be an abrasive material. The abrasive can be any particulate material that is insoluble in the fluid carrier. Examples of useful insoluble chemical components include, but are not limited to homogeneous abrasive particles, mixed abrasive particles, multi-component abrasive particles, organic abrasive particles i.e., polystyrene or polyurethane, inorganic abrasive particles, metal oxide abrasive particles, insoluble chemical particles and the mixtures thereof. In addition, insoluble chemical components can be particles coated with a dissimilar type of particle, inorganic or organic particles coated with a desired polymer layer or particles with an absorbed layer of chemical components such as silane treated abrasive particles. While particles are used as a mechanical component of a polishing composition they can also be used as a chemical component, particularly if the particle surface is chemically activated.

One useful class of insoluble chemical components are insoluble inorganic materials in particulate form such as a metal oxide, a ceramic material or diamond. Useful metal oxide abrasive may be selected from the group including alumina, titania, zirconia, germania, silica, ceria and mixtures thereof that are produced by any techniques known to those skilled in the art.

Another class of useful insoluble compounds include solid catalysts, and in particular heterogeneous solid catalysts. The purpose of the solid catalyst is to at least catalyze the formation of activated peroxy or oxidizing species on the surface of the solid catalyst. The term “heterogeneous solid catalyst” is used herein to refer to compositions in which the solid catalyst is distinct from the liquid phase and not significantly soluble (essentially insoluble) in the chemical mechanical composition liquid phase. In other words, the “active” insoluble solid catalyst can be mechanically or physically separated from the liquid phase. For example, the solid catalyst can be removed by a mechanical process such as centrifugation or filtration. This is distinct from a homogeneous catalyst system where the soluble catalyst exists in the liquid phase. The heterogeneous solid catalysts can be a homogeneous composition of the active catalyst, or the active heterogeneous solid catalyst can be chemically or physically associated with the surface of the preferred abrasive as molecular species, as a small particle or as a monolayer. Because the catalyst used in this invention is a solid catalyst, the catalyzed reactions occur on or near the solid catalyst surface. Therefore, the solid catalysts are preferably small particles with high surface areas. The solid catalysts should have a mean particle diameter less than about 1 micron and a surface area greater that about 10 m²/g and less than about 250 m²/g. It is more preferred that the solid catalysts have a mean particle diameter is less than about 0.5 microns and most preferably less than about 0.25 microns. The same preferred particle characteristics will also optimize the colloidal stability of the solid catalysts in the polishing compositions and slurries of this invention.

Heterogeneous solid catalysts may also act as an abrasive when present in large enough amounts in the polishing compositions. Since the useful catalytically active sites on the solid catalyst are restricted to the catalyst particle surface, the active catalyst will always be present even if portions of the abrasive surface is removed.

The solid catalyst may be an energy activated or photoactivated solid catalyst. By “photoactive” it is meant that the solid catalyst catalytic activity is enhanced by bombarding the solid catalyst with photons of light or electromagnetic radiation. It is preferred that catalytic activity of a photoactive solid catalyst of this invention is enhanced by exposing the catalyst to a source that emits light at wavelengths in the UV range of from about 1 to about 800 nm. It is most preferred that the activity of the photoactive solid catalyst is enhanced by a UV light source having a wavelength of from 200-400 nm and most preferably a UV wavelength less than about 390 nm.

Solid catalysts useful in the compositions of this invention include all solid materials where photoelectric stimulation causes electrons in the solid material to be excited to a conducting band. Non-limiting examples of useful solid catalysts are semiconducting solid oxides having the formula MₓO_{y} wherein M is selected from Ti, Ta, W, V, Nb, and mixtures thereof, where x and y are each the same or different numbers and wherein x and y are both greater than 0. Preferably, x and y are each individually greater than 0 and less than about 5.

Preferred photoactive solid catalysts are oxides of titanium including TiO₂, Ti₂O₃, and mixtures thereof.

The Fluid Carrier

In most, but not all cases, the useful polishing composition will include a fluid carrier that may be selected from water, organic liquids or inorganic liquids or combinations thereof. Examples of useful organic liquids include hydrocarbon liquids, and organic solvents such as alcohols, acetone, ketone and benzene. The organic liquid may further be selected from mineral oils, oils derived from vegetable sources such as corn oil, and similar oils. In an example of an inorganic liquid that is useful as a carrier liquid would be liquid silicone.

Polishing compositions which can be useful for polishing and forming the end faces of fiber optic connectors are described in U.S. Pat. Nos. 5,759,917, 5,783,489, 5,954,997, 5,958,288, 5,980,775, 5,993,686, 6,015,506, 6,033,596, 6,039,891, 6,062,968, 6,063,306, 6,083,419, 6,086,787, 6,117,000, 6,126,853 and 6,309,560. The specifications of each of which are incorporated herein by reference.

The desired end face geometry may vary depending upon the type of connectors being polished. FIG. 5D shows the desired end face geometry of a single fiber connector. In FIG. 5D, end of fiber 16 protrudes slightly from ferrule material 12. It is preferred that the finished optical fiber end are either even with or protrudes slightly from the plane of the ferrule material for single fiber connectors. For multiple fiber connectors, it is preferred that the optical fibers protrude slightly from the plane of the ferrule material to allow for efficient and uniform connection of the fiber optic connector to an optical device or to a second fiber optic connector.

An important aspect of the processes of this invention is the use of polishing techniques and preferably chemical mechanical polishing (CMP) to controllably remove material from end face 5 of ferrule 12 in order to shape and condition the end face surface. In the normal course of the chemical mechanical polishing of an integrated circuit, the goal is to form a planar integrated circuit surface. That is not generally the goal of optical fiber ferrule polishing. It may be desirable, in some instances, to obtain a planar ferrule end face. However, the ferrule polished by the methods of this invention may have a convex surface, a concave surface, a skewed surface and so forth. The polishing process can be prepared by hand, with semi-automated or automated polishing apparatuses. The end face finishing processes can utilize a polishing substrate such as a cloth or a polishing pad alone or in conjunction with a liquid or aqueous polishing composition. It is most preferred that end face finishing techniques and apparatuses are used to remove at least part of one material or material layer from the fiber optic connector end face.

In a typical CMP process, the connector end face surface that is being polished is placed into contact with a moving polishing pad. A carrier applies pressure against the backside of the connector in order to cause a polishing pad to contact the connector end face at a controlled pressure. During the polishing process, the pad and/or connector may be rotated while a pressure is maintained between the connector end face and polishing pad. A polishing composition is applied to the interface between the polishing pad and the end face being polished. The polishing composition can be applied to the interface by applying the polishing composition to the polishing pad surface, to the end face or to both. The polishing composition can be applied to the interface either intermittently or continuously and the application of the polishing composition can begin prior to or after the polishing pad is brought into contact with the end face surface being finished. The term “applying a polishing composition” as it used in the specification and claims is not time limited and refers to the application of a polishing composition either before or after a polishing substrate is moved into contact with the surface being polished.

As discussed above, the polishing composition may be formulated to include chemicals that react with and/or soften the surface of the material being polished. The polishing process further may include an insoluble chemical in the form of a solid catalyst, particulate abrasive and the like that assists in removing a portion of one or more of the optical connector end face materials that have been treated by a reaction between the polishing composition and the end face material. The insoluble chemical may be incorporated into the polishing pad such as polishing pads disclosed in U.S. Pat. No. 6,121,143 the specification of which is incorporated herein by reference, it may be incorporated into the polishing composition, or both.

The fiber optic connector end faces may be finished according to the methods of this invention by manual, semi-automated or fully automated methods as well as combinations thereof. In a manual method, the use of polishing composition will typically be applied to a cloth or to a pad and thereafter applied to the ferrule of the optical connector surface which is thereafter polished by hand. In a semi-automated or automated system, one or more connectors will be held in a cassette or a holder and orientated perpendicularly to or at an angle with respect to a polishing pad. The polishing composition is thereafter applied to the polishing pad and/or to the connector end face after which the connector end faces and polishing pads are brought into contact with the one another and moved in relationship to one another in order to finish the fiber optic connector end faces.

Ingredients in the polishing composition or slurry initiate the polishing process by chemically reacting with and or by physically removing material on the surface of the end face. The polishing process is facilitated by the movement of the pad relative to the end face as the chemically reactive polishing composition or slurry is provided to the substrate/pad interface. End face finishing continues in this manner until the desired end face geometry surface finish is achieved.

The movement of the polishing pad in relationship to the substrate can vary depending upon the desired end face finish and geometry. Often, the polishing pad substrate is rotated while the end face remains stationary. Alternatively, the polishing pad and the end face can both move with respect to one another. The polishing substrates and in particular the polishing pads can be moved in a linear manner, they can move in a orbital or a rotational manner or they can move in a combination of the directions.

As discussed above, the formulation of polishing compositions is an important factor in the processes of this invention. Depending on the choice of ingredients such as oxidizing agents, film forming agents, acids, bases, surfactants, complexing agents, stopping compounds, abrasives, fluids and other useful additives, the polishing composition can be tailored to provide effective polishing of the dissimilar end face materials at desired polishing rates, with the desired surface geometry, while minimizing surface imperfections, defects, dishing and doming.

Another aspect of this invention is the use of polishing compositions that reduce defectivity at the end face of optical fiber connectors. The defectivity reduction can be achieved with the use of polishing compositions having a solid component with particular particle size range, by using specific chemical additives and/or by using a coated particle in the polishing step.

While the present invention has been described by means of specific embodiments, it will be understood that modifications may be made without departing from the spirit of the invention. The scope of the invention is not to be considered as limited by the description of the invention set forth in the specification and examples, but rather as defined by the following claims.

### EXAMPLE 1

This Example describes the preparation of a preferred polishing composition comprising an aqueous medium including at least one abrasive and at least one alcoholamine. The composition may also include optional additives such as a buffering agent.

The abrasive is typically a metal oxide abrasive. The metal oxide abrasive may be selected from the group including alumina, titania, zirconia, germania, silica, ceria and mixtures thereof. Other useful particles include, but are not limited to aluminum nitride and silicon carbide. The preferred polishing composition may include from about 0.1 to about 55 weight percent or more of an abrasive. It is more preferred, however, that the polishing composition of this invention includes from about 0.5 to about 15 weight percent abrasive and most preferably, 0.5 to about 3.0 wt % of an abrasive. The metal oxide abrasive may be produced by any techniques known to those skilled in the art.

A metal oxide abrasive can be incorporated into the aqueous medium of the polishing composition as a concentrated aqueous dispersion of metal oxides. The concentrated aqueous dispersion of metal oxides comprising from about 3% to about 45% solids, and preferably between 10% and 20% solids. The pH of the slurry may be adjusted away from the isoelectric point to maximize colloidal stability. A most preferred abrasive of this invention is fumed silica.

The preferred polishing composition further includes at least one alcoholamine. It has been found that the addition of an alcoholamine to the polishing slurry enhances the polishing rate of the ferrule material in comparison to the optical fiber material. Any alcoholamines may be used in the compositions of this invention. Examples of useful alcoholamines include ethanol amines, propanol amines, primary alcoholamines, secondary alcoholamines, tertiary alcoholamines and so forth. A most preferred type of alcoholamines useful in the compositions of this invention are tertiary alcoholamines. Examples of useful tertiary alcoholamines include triethynol amine, dialkylethynol amine, alkyl diethynol amine and the like. It is preferred that the tertiary alcoholamine include two methyl groups and one isopropyl group. A most preferred tertiary alcoholamine is 2-dimethylamino-2-methyl-1-propanol (DMAMP).

The alcoholamine is present in the preferred compositions of this invention will vary from about 50 ppm to about 2 wt % or more. More preferably, the alcoholamine should be present in the composition of this invention in an amount ranging from about 500 ppm to about 1.0 wt %.

An optional buffering agent may be added to the preferred compositions. The buffer functions in the compositions of this invention to make the slurries more resistant in pH change. Any buffer which possesses an acid/conjugate base with a pKa close to the desired composition pH is preferred as a composition buffer. The actual pH can be approximated with the equation:

pH=pKa++log[conjugate base]/[acid]

which may be used in the compositions of this invention. Especially useful buffers include carbonate and bicarbonate buffers such as ammonium bicarbonate. If a buffer is used, then it will be present in the preferred compositions of this invention in amounts ranging from about 0.01 to about 1.0 wt %. It is most preferred that the buffer is present in an amount ranging from about 0.01 to about 0.15 wt %.

### EXAMPLE 2

In this Example fiber optic ferrule end faces were polished with a variety of polishing compositions and polishing pads. The polishing results are reported in Table I.

Procedure:

An 8-fiber optical connector with an 8 degree angle polish were polished in this Example using the slurries and pads identified below. The optical fiber connector ferrule material was silicon while the optical fiber was made of silica. The polishing was performed with a US-CONEC MTA-030A polishing machine at a down force of 0.7 pounds and 100% rotational/orbital velocity. The polishing was performed in five increments of 60, 60, 120, 240, and 480 seconds for a cumulative polishing time of 960 seconds or 16 minutes.

Polishing Compositions and Pads

The slurries identified in Table 1 were applied at an initial volume of 10 mL and replenished at each 4 minute polishing interval. After each polishing increment, the ferrules were rinsed with distilled water, dried with compressed air and cleaned with isopropanol on a lint-free cloth. Interferometry data was collected for a selected ferrule at each interval and for all ferrules upon the completion of polishing. Descriptions of the polishing compositions and polishing pads identified in Table I are found immediately below.

Slurries:

Composition 1: 12 wt % fumed silica (90 m²/g) solids, KOH to pH ˜11, buffered

Composition 2: 2 wt % fumed silica (90 m²/g) solids, 1500 ppm DMAMP

Composition 3: 500 ppm HN03-15 wt % fumed silica (90 m²/g) at pH 5.5

Composition 4: 10.3 wt % fumed alumina −1000 ppm HNO₃ 10.3% solids

Composition 5: 6 wt % fumed silica (90 m²/g) solids, 5000 ppm DMAMP

Composition 6: 10.3 wt % fumed silica (90 m²/g) solids and 1500 ppm DMAMP

Pads

PH—sintered urethane polishing pad

PB—sintered urethane polishing pad w/ subpad

Results:

The polishing results are reported in Table 1, below. The results are end of polishing results reported by polishing composition. The end of polishing results are an average of the measurement of the surface characteristics of all fiber ends associated with the polished ferrule end face.

TABLE 1

| | | | | Pla | | Group |
|---|---|---|---|---|---|---|
| | Polishing | t | X- | Diff | Mean Fiber | mean |
| | film or | (sec) | ROC | Ht | protrusion | protrusion |
| Slurry | pad | cum. | (mm) | (um) | (um) | (um) |
| 1 | PH | 960 | 4882.13 | 0.15 | 0.14 | 0.26 |
| 1 | PB | 960 | 1309.66 | 0.31 | 0.84 | 0.75 |
| 2 | PH | 960 | 1403.11 | 0.38 | 1.47 | 1.31 |
| 2 | PB | 960 | 1227.96 | 0.45 | 0.83 | 0.79 |
| 3 | PH | 960 | 2942.11 | 0.23 | 0.08 | −0.03 |
| 4 | PH | 960 | 2775.62 | 0.24 | 0.23 | 0.38 |
| 4 | PB | 960 | 4474.64 | 0.08 | 0.20 | 0.34 |
| 5 | PH | 960 | 1686.56 | 0.33 | 0.65 | 0.57 |
| 5 | PB | 960 | 2535.73 | 0.30 | 0.53 | 0.48 |
| 6 | PB | 960 | −4636.57 | 0.29 | 0.07 | 0.60 |
| 6 | PH | 960 | 1784.69 | 0.36 | 0.35 | 0.33 |
| 1 | PB | 960 | 912.31 | 0.51 | 0.58 | 0.59 |

In Table I, X-ROC is a measure of unflatness or curvature of the ferrule surface that fits all optical fiber points across the face of the ferrule. Higher values of X-ROC are desired for ferrules including multiple optical fibers. “PLA DIFF HT” refers to planar differential height which is the difference in protrusion of the highest to lowest protruded fiber in the polished multiple fiber ferrule. A planar differential height less than 0.5 is preferred for multiple fiber ferrules. “Mean fiber protrusion” is a measure of the average protrusion of fibers in a single randomly selected ferrule from the surface of the ferrule material. The “group mean protrusion” is the average of all optical fibers in the multiple ferrule polishing run.

According to the polishing results reported in Table I the addition of the chemical additive DMAMP to Composition 1 (to give Composition 2) had a significant effect on the control of the relative polishing rates of fiber and ferrule. The DMAMP allowed the solids in Composition 2 be decreased to one-sixth of Composition 1 while, at the same time, Composition 2 had a higher silicon polishing rate that Composition 1 as reflected by a larger fiber protrusion.

Compositions 3 and 4 were similar except that Composition 3 included silica and Composition 4 included alumina. The polishing results reported in Table I indicate that the selection of the solid component—alumina vs. silica—had a positive impact on fiber protrusion results.

Compositions 5 and 6 were formulated to include an amount of DMAMP falling between the amount included in Composition 2 and Composition 1—which does not include DMAMP—in a effort to determine the effect, if any of the amount of DMAMP in the polishing composition on fiber protrusion. The results reported in Table I indicate that protrusion improves with increasing amounts of DMAMP in the polishing composition but that the levels (of abrasive and DMAMP) used in Composition 2 appear to be closest to optimum of the formulations attempted in this experiment.

### EXAMPLE 3

In this Example, a fiber optic connector including a single optical fiber was polished with a variety of polishing compositions. The connector consisted of a ferrule surrounding an optical fiber. The ferrule material was zirconia and the optical fiber material was silica.

Fiber optic connector polishing compositions that include only an abrasive material in solution present significant processing problems including problems with (1) solids settling from the abrasive solution prior to use; (2) problems with connectors becoming cemented into the connector polishing fixture during polishing; and (3) problems with cleaning the abrasive polishing materials from the polished connector surfaces. A variety of soluble and insoluble chemical additive were incorporated into polishing composition in this Example and then the polishing properties and processability of each Composition were evaluated as set forth below.

The procedure used to polish the connector end face is essentially identical to the procedure described in Example 2. The polishing pad used was a polyurethane polishing pad and the polishing was conducted for 60 seconds. The polishing compositions used are reported in Table II below. In the polishing compositions “PEG” refers to polyethylene glycol and “PVP” refers to polyvinylpyrrolidone.

The polishing results are reported in Table II on the next page.

TABLE II

| | | | | PVP | | | Relative | Relative | |
|---|---|---|---|---|---|---|---|---|---|
| | Silica | Ceria | PEG (600 | (10k | | | ferrule | ferrule | |
| | (˜25 nm | (˜110 nm | mw) | mw) | | | polish | polish | Apex |
| | diam.) | (diam.) | Conc. | Conc. | | AVG | rate | rate | Offset |
| Slurry | % solids | % solids | (ppm) | (ppm) | pH | ROC | (nm/min) | STDEV | (μm) |
| 1 | 14.0 | 1.0 | 500 | 0 | 4.0 | 21.73 | −167.95 | 10.67 | 10.38 |
| 2 | 12.0 | 1.0 | 100 | 0 | 4.00 | 20.07 | −127.18 | 15.96 | 17.20 |
| 3 | 2.0 | 1.0 | 500 | 0 | 3.90 | 20.64 | −100.78 | 8.43 | 19.76 |
| 4 | 12.0 | 1.0 | 1000 | 0 | 4.10 | 22.28 | −97.33 | 6.18 | 43.55 |
| 5 | 8.0 | 1.0 | 500 | 0 | 4.00 | 22.09 | −45.18 | 16.92 | 26.21 |
| 6 | 4.0 | 1.0 | 100 | 0 | 4.10 | 20.06 | −7.05 | 19.07 | 15.31 |
| 7 | 8.0 | 1.0 | 2000 | 0 | 4.10 | 19.86 | −2.43 | 10.59 | 13.05 |
| 8 | 4.0 | 1.0 | 1000 | 0 | 4.10 | 19.62 | 1.00 | 12.92 | 20.87 |
| 9 | 14.0 | 1.0 | 0 | 500 | 4.40 | 20.98 | −97.53 | 15.05 | 24.07 |
| 10 | 12.0 | 1.0 | 0 | 100 | 4.40 | 21.71 | −60.68 | 5.21 | 26.65 |
| 11 | 2.0 | 1.0 | 0 | 500 | 4.00 | 20.40 | −52.63 | 7.99 | 19.91 |
| 12 | 4.0 | 1.0 | 0 | 100 | 3.60 | 22.02 | −48.60 | 14.44 | 37.74 |
| 13 | 8.0 | 1.0 | 0 | 2000 | 4.30 | 20.39 | −44.08 | 12.67 | 17.83 |
| 14 | 12.0 | 1.0 | 0 | 1000 | 4.30 | 21.35 | −29.20 | 6.57 | 26.74 |
| 15 | 8.0 | 1.0 | 0 | 500 | 4.20 | 21.40 | −18.85 | 8.62 | 37.49 |
| 16 | 4.0 | 1.0 | 0 | 1000 | 4.00 | 20.17 | −9.25 | 14.47 | 17.97 |
| 17 | 4.0 | 1.0 | 0 | 2000 | 4.10 | 21.31 | 0.05 | 4.81 | 30.72 |
| 18 | 12.0 | 0.0 | 0 | 1000 | 4.10 | 21.51 | −7.38 | 5.82 | 29.10 |
| 19 | 4.0 | 0.0 | 0 | 2000 | 4.10 | 20.08 | 124.28 | 57.84 | 19.66 |
| 20 | 8.0 | 0.0 | 0 | 2500 | 3.90 | 20.59 | −10.75 | 5.63 | 25.24 |
| 21 | 8.0 | 0.0 | 0 | 1500 | 4.00 | 20.44 | 32.80 | 7.65 | 22.25 |
| 22 | 8.0 | 1.0 | 0 | 2500 | 4.10 | 21.49 | −78.35 | 10.55 | 20.02 |
| 23 | 8.0 | 1.0 | 0 | 1500 | 4.00 | 21.61 | −83.15 | 6.21 | 24.44 |
| 24 | 12.0 | 1.0 | 0 | 2000 | 3.90 | 22.60 | −119.50 | 5.98 | 22.98 |
| 26 | 16.0 | 0.0 | 0 | 1500 | 4.10 | 21.95 | −108.03 | 11.84 | 15.64 |
| 26 | 12.0 | 0.0 | 0 | 2000 | 3.90 | 21.56 | −38.03 | 11.75 | 20.36 |

| | | | Settled | | Removal | | | |
|---|---|---|---|---|---|---|---|---|
| | Scratch- | Scratch- | solids | Top layer | of ferrule | Residue | | |
| | free | free | thickness | thickness | from | on fiber | | Selection |
| | ferrule | fiber | (mm) | (mm) | fixture | face | Foaming | Criterion |
| 1 | N | Y | 8 | 3 | vd | some | moderate | 0 |
| 2 | Y | Y | 6 | 3 | vd | some | moderate | 0 |
| 3 | N | N | 10 | 5 | ve | some | moderate | 0 |
| 4 | nearly | Y | 0 | 0 | easy | some | heavy | 0 |
| 5 | Y | Y | 7 | 5 | sd | some | moderate | 0 |
| 6 | nearly | Y | 7 | 5 | easy | some | moderate | 0 |
| 7 | nearly | Y | 0 | 1 | ve | some | heavy | 0 |
| 8 | Y | Y | 8 | 3 | easy | some | moderate | 0 |
| 9 | N | Y | 14 | 3 | sd | some | none | 0 |
| 10 | N | Y | 7 | 5 | vd | some | none | 0 |
| 11 | Y | Y | 8 | 5 | ve | some | none | |
| 12 | nearly | Y | 5 | 5 | sd | some | none | 0 |
| 13 | Y | Y | 0 | 3 | ve | some | none | −44.08 |
| 14 | N | Y | 0 | 1 | easy | some | none | 0 |
| 15 | N | Y | 13 | 5 | sd | some | none | 0 |
| 16 | Y | Y | 0 | 1 | ve | some | none | −9.25 |
| 17 | Y | Y | 0 | 5 | ve | some | light | 0 |
| 18 | N | Y | 0 | — | easy | significant | none | 0 |
| 19 | N | Y | 0 | — | easy | significant | moderate | 0 |
| 20 | Y | Y | 0 | 5 | ve | significant | none | 0 |
| 21 | N | Y | 0 | 3 | ve | significant | none | 0 |
| 22 | Y | Y | 0 | 7 | ve | some | none | −78.35 |
| 23 | Y | Y | 0 | 3 | easy | some | none | −83.15 |
| 24 | Y | Y | 0 | 1 | ve | some | none | −119.5 |
| 25 | N | Y | 0 | — | sd | significant | none | 0 |
| 26 | N | Y | 0 | 1 | easy | significant | none | 0 |

Several of the Table II headings are the same as those included in Table I. In Table II, the first several columns refer to the slurry ingredients and properties. The term “Apex Offset” refers to the location of the peak of the end face curve relative to the fiber end face. “Scratch Free Ferrule?” and Scratch Free Fiber?” refer to the presence or absence of observed scratches in the respective materials. The “Settled Solid Thickness” and Top Layer Thickness” refer to the dispersability of the slurry in a container prior to its use wherein high settled solid thickness and low top layer thickness indicate some slurry settling prior to use. “Removal of Ferrule From Fixture” indicates the ease or difficulty of the removal of the polished ferrule from the fixture wherein “vd”=very difficult, “ve”=very easy, and “sd”=slightly difficult. Difficulty in manually removing the ferrule from the fixture will typically occur when the polishing slurry causes the ferrule to become adhered to the fixture. The “Residue on Fiber Face” refers to slurry residue on the fiber face after polishing. “Foaming” refers to the degree of foam produced by the slurry during the polishing process. The “Selection Criteria” is 0 for any slurry that foams, that is somewhat or very difficult to remove from the fixture, or that leaves significant residue of the fiber face. For all other slurries, the Selection Criteria” is identical to the relative ferrule polishing rate.

The polishing and processability results reported in Table II demonstrate that all of the Compositions were able to polish the optical connector. Only Compositions 13, 16 and 22-24, however, met all four processability criteria of foaming, removal of ferrule from fixture, residue on fiber face, and scratching. From a polishing performance standpoint Compositions 5 and 8 exhibited very good polishing results. Further, a comparison of the polishing results of Compounds 20 and 22 shows that a solid ingredient, such as ceria, can play a chemical role in ferrule polishing in that the addition of a small amount of ceria into Composition 20 to give Composition 22 resulted in a polishing composition that met all processability criteria in comparison to its ceria-free counterpart, particularly with regard to surface cleanability.

### EXAMPLE 4

This Example describes ingredients that can be included in polishing compositions used to polish single fiber connector end faces.

Single fiber connectors can be composed of a variety of optical fiber material and ferrule material combinations. Table III below identifies some well-known single optical fiber connector ferrule materials. Table III also identifies soluble chemical components and insoluble chemical components that may be combined with fluid carriers such as water to form compositions for polishing the end face materials set forth in Table III.

TABLE III

| | Polishing | | |
|---|---|---|---|
| Ferrule | Composition | Ingredient | |
| Material | Ingredients | Type | Ingredient Effect |
| ZrO₂ | 1-5 wt % | Insoluble | Increases ZrO₂ |
| | silica | additive | and/or glass |
| | | | polishing rate |
| | 0.1-5 wt % | stopping | selectivity |
| | polyethyleneimine | compound | |
| Homogenous | | | |
| Polymer | | | |
| | 1-5 wt % | insoluble | increase polymer |
| | alumina | additive | polishing rate |
| | 1-5 wt % | oxidizer | increase polymer |
| | H₂O₂ | | polishing rate |
| | 100-100,000 ppm | polymer/ | improve |
| | polyethylene glycol | surfactant | cleanability |
| | pH > 7 | | |
| Stainless | | | |
| Steel | | | |
| | 0.5-5 wt % | oxidizer | increase |
| | ferric nitrate | | polishing rate |
| | 0.1-5 wt % | organic | increase |
| | oxalic acid | acid | polishing rate |
| | 1-10 wt % | insoluble | increase |
| | silica | additive | polishing rate |

### EXAMPLE 5

This Example describes ingredients can be included in polishing compositions used to polish multi-fiber connector end faces.

Multi fiber connectors can be composed of a variety of optical fiber material and ferrule material combinations. Table IV below identifies some well-known multi-fiber connector ferrule materials. Table IV also identifies soluble chemical components and insoluble chemical components that may be combined with fluid carriers such as water to form compositions for polishing the fiber optic connector end face materials described in Table IV.

TABLE IV

| | Polishing | | |
|---|---|---|---|
| Ferrule | Composition | Ingredient | Ingredient |
| Material | Ingredients | Type | Effect |
| Glass Reinforced | | | |
| Polymer | | | |
| | 1-5 wt % | oxidizer | accelerate polymer |
| | H₂O₂ | | polishing |
| | 5-13 wt % | insoluble | accelerate |
| | silica | ingredient | polishing |
| Silicon | | | |
| | 0.05-1.0 wt % | amino | selectivity |
| | triethanolamine | compound | modifier |
| | 1-5 wt % | insoluble | increase |
| | silica | additive | polishing rate |
| Homogenous | | | |
| Polymers | | | |
| | 1-10 wt % | insoluble | accelerate |
| | alumina | additive | polishing |
| | 10-10,000 | polymer/ | improve cleanability |
| | ppm PEG | surfactant | and/or selectivity |
| | pH @ 5 | | |

### EXAMPLE 6

This Example describes ingredients that can be included in polishing compositions used to polish fiber array connector end faces.

Fiber array connectors can be composed of a variety of optical fiber material and ferrule material combinations. Table V below identifies some well-known fiber array connector ferrule materials. Table V also identifies soluble chemical components and insoluble chemical components that may be combined with fluid carriers such as water to form compositions for polishing the end face materials disclosed in Table V.

TABLE V

| | Polishing | | |
|---|---|---|---|
| Ferrule | Composition | Ingredient | Ingredient |
| Material | Ingredients | Type | Effect |
| Glass | | | |
| | 0.1-4.0 wt % | insoluble | improve |
| | ceria | additive | polishing rate |
| | 0.1-5.0 wt % | organic | control polishing |
| | malonic acid | acid | selectivity |
| | pH @ 4 | | |
| Silicon | | | |
| | 1-15 wt % | insoluble | |
| | silica | additive | |
| | 50-50,000 ppm | amino and ammo- | improve cleanability |
| | polyethylenimine | nium compound | and selectivity |
| Ceramic | | | |
| Materials | | | |
| | 1-10 wt % | insoluble | accelerate |
| | alumina | additive | polish rate |
| | 0.1-3.0 wt % | polishing | increase ceramic |
| | NH₄NO₃ | accelerator | polishing rate |
| | pH @ 8 | | |

### EXAMPLE 7

This Example describes ingredients that can be included in polishing compositions for polishing pig tail fiber connectors.

Pig tail fiber connectors can be composed of a variety of optical fiber material and ferrule material combinations. The table included below identifies the some of the potential fiber optic connection materials. Table VI below identifies some well-known pig-tail connector ferrule materials. Table VI also identifies soluble chemical components and insoluble chemical components that may be combined with fluid carriers such as water to form compositions for polishing the end face materials disclosed in Table VI.

TABLE VI

| | Polishing | | |
|---|---|---|---|
| Ferrule | Composition | Ingredient | Ingredient |
| Material | Ingredients | Type | Effect |
| Copper | | | |
| | 1-5 wt % | oxidizing | polish |
| | H₂O₂ | agent | selectivity |
| | 1-10 wt % | insoluble | accelerate |
| | silica | additive | polish rate |
| | 0.05-1.0 wt % | inhibitor | inhibits |
| | benzotriazole | | corrosion |
| | 0.1-5.0 wt %% | organic | increase metal |
| | tartaric acid | acid | rate/selectivity |
| | pH @ 8 | | |
| | (NH₄OH) | | |
| Stainless | | | |
| Steel | | | |
| | 0.1-5.0 wt % | oxidizer | polishing |
| | persulfate | | rate |
| | 1.0-5.0 wt % | insoluble | accelerate polish- |
| | alumina | additive | ing rate |
| | 0.05-1.0 wt % | acid | polishing rate |
| | of phosphate | | |
| | 50-50,000 ppm | polymer/ | improved cleanability |
| | PEG | surfactant | and selectivity |
| | pH @ 4 | | |

What is claimed is:

1. A method for polishing a substrate including an optical material portion and a non-optical material portion by the steps comprising:
(a) applying a polishing composition to the substrate; and
(b) polishing the substrate with a polishing substrate until at least a portion the optical material portion is removed from the substrate and at least a portion of the non-optical material portion is removed from the substrate.

2. The method of claim 1 wherein the polishing is accomplished by a combination of mechanical polishing and chemical polishing.

3. The method of claim 1 wherein the polishing composition includes at least one soluble chemical component.

4. The method of claim 3 wherein the soluble chemical component is selected from the group consisting of oxidizing agents, organic acids, catalysts, etching inhibitors, amino compounds, ammonium compounds, film forming agents, hydroxylamines, polishing accelerators, stopping compounds, inorganic additives, and combinations thereof.

5. The method of claim 4 wherein the soluble chemical of the polishing composition chemically polishes the substrate.

6. The method of claim 1 wherein the polishing composition includes at least one insoluble chemical component.

7. The method of claim 6 wherein the insoluble chemical component polishes the substrate by a method selected from chemical polishing or mechanical polishing.

8. The method of claim 1 wherein polishing step (b) forms an optically curved surface on the substrate optical material portion.

9. The method of claim 1 wherein the optical material portion of the polished substrate surface protrudes from the non-optical material portion of the polished substrate.

10. The method of claim 1 wherein the optical material portion of the polished substrate surface is recessed in the non-optical material portion of the polished substrate.

11. A method for polishing an end face of an optical fiber connector that includes an optical material portion and a ferrule material portion by the steps comprising:
(c) applying a polishing composition to the connector end-face; and
(d) polishing the optical material portion and the ferrule material portion of the connector simultaneously with a polishing substrate until at least a portion the optical material portion and at least a portion of the ferrule material portion are removed from the end-face wherein the optical material portion and ferrule material portion are removed by a combination of chemical and mechanical polishing.

12. The method of claim 11 wherein the substrate is an optical fiber connector comprising a single optical fiber surrounded by a ferrule material.

13. The method of claim 11 wherein the substrate is an optical fiber connector comprising a plurality of optical fibers wherein each optical fiber is surrounded by a ferrule material.

14. The method of claim 11 wherein the optical material portion is at least one optical fiber.

15. The method of claim 11 wherein the polishing composition has a ferrule material polishing rate that is greater than its optical material polishing rate.

16. The method of claim 11 wherein the polishing composition has a ferrule material polishing rate that is less than its optical material polishing rate.

17. The method of claim 11 wherein the polishing composition has a ferrule material polishing rate that is essentially equal to its optical material polishing rate.

18. The method of claim 11 wherein the polishing composition includes at least one soluble chemical component.

19. The method of claim 18 wherein the soluble chemical component is selected from the group consisting of oxidizing agents, organic acids, catalysts, etching inhibitors, amino compounds, ammonium compounds, film forming agents, hydroxylamines, polishing accelerators, stopping compounds, inorganic additives, and combinations thereof.

20. The method of claim 11 wherein the polishing composition includes at least one insoluble chemical component.

21. The method of claim 20 wherein the insoluble chemical component is at least one abrasive.

22. The method of claim 21 wherein the abrasive is selected from the group consisting of a homogeneous abrasive particles, mixed abrasive particles, coated abrasive particles, organic abrasive particles, inorganic abrasive particles, metal oxide abrasive particles, surface treated abrasive particles, surface modified abrasive particles, polymer coated particles, chemically active particles, and mixtures thereof.

23. The method of claim 11 wherein the polishing composition includes at least one fluid carrier.

24. The method of claim 23 wherein the fluid carrier is selected from water, an organic liquid or an inorganic liquid.

25. The method of claim 11 wherein polishing step (b) proceeds until the optical material is coincident with the ferrule material.

26. The method of claim 11 wherein the connector optical material portion is at least one optical fiber having an end face that is surrounded by the ferrule material portion wherein the ferrule material portion includes a surface.

27. The method of claim 26 wherein polishing step (b) proceeds until the optical fiber end face protrudes from about 0.5 to about 3 microns beyond the surface of the ferrule material.

28. The method of claim 26 wherein polishing step (b) proceeds until the optical fiber end face and the ferrule material surface are essentially co-planar.

29. The method of claim 28 wherein the optical fiber end face lies at a distance of from about 0 to about 125 nm beyond the ferrule material surface.

30. The method of claim 26 wherein polishing step (b) proceeds until the optical fiber end face is recessed in the ferrule material.

31. The method of claim 30 wherein the recessed optical fiber end face has a distance of from about 0 to about 250 microns below the ferrule material surface.

32. The method of claim 11 wherein the ferrule material comprises a metal and the polishing composition comprises a soluble material selected from the group consisting of oxidizing agents, organic acids, corrosion inhibitors, and film forming agents, and combinations thereof.

33. The method of claim 11 wherein the ferrule material comprises a material selected from the group consisting of a metal that is coated with a polymeric material, a metal oxide that is coated with a polymeric material, and both a metal and a metal oxide that are coated with a polymeric material, and the polishing composition comprises a soluble material selected from the group consisting of an oxidizing agent, organic acids, surfactants, polishing accelerators, and combinations thereof.

34. The method of claim 11 wherein the ferrule includes two dissimilar materials and the polishing composition includes at least one soluble material.

35. The method of claim 11 wherein the ferrule material comprises a polymer and the polishing composition comprises an insoluble material selected from the group consisting of alumina, titania, zirconia, and combinations thereof.

36. The method of claim 11 wherein the optical material comprises silicon oxide and the polishing composition comprises cerium oxide.

37. The method of claim 11 wherein the ferrule material comprises a silicon material and the polishing composition includes at least on compound selected from the group consisting of a cerium compound, organic acids, hydroxylamines, amino compounds and polishing accelerators.

38. The method of claim 11 wherein the ferrule material comprises at least two dissimilar materials and the polishing composition comprises a soluble material selected from the group consisting of oxidizing agents, stopping compounds, alcoholamines, surfactants, film forming agents and combinations thereof.

39. The method of claim 11 wherein polishing step (b) comprises the further steps of
(i) bringing the polishing substrate into contact with the exposed surface of the connector; and
(ii) moving the polishing substrate in relation to the exposed connector surface.

40. The method of claim 39 wherein the polishing substrate is a polishing pad.

41. The method of claim 40 wherein the polishing pad is a fixed abrasive polishing pad.

42. A method for preparing a polishing composition for use in finishing the end face of a fiber optic connector wherein the connector includes a ferrule enclosing at least one optical fiber wherein the method comprises the steps of:
(a) identifying the ferrule material;
(b) identifying the optical fiber material;
(c) identifying the desired connector end face geometry; and
(d) selecting one or more ingredients for a polishing composition that will polish the ferrule material and the fiber optic material at rates relative to each other that will produce the desired connector end face geometry.

43. The method of claim 42 wherein the polishing composition has a chemical polishing component and a mechanical polishing component.

44. The method of claim 42 wherein the ferrule material comprises a metal and the polishing composition comprises a soluble material selected from the group consisting of oxidizing agents, organic acids, corrosion inhibitors, and film forming agents, and combinations thereof.

45. The method of claim 42 wherein the ferrule material comprises a material selected from the group consisting of a metal that is coated with a polymeric material, a metal oxide that is coated with a polymeric material, and both a metal and a metal oxide that are coated with a polymeric material, and the polishing composition comprises a soluble material selected from the group consisting of an oxidizing agent, organic acids, surfactants, polishing accelerators, and combinations thereof.

46. The method of claim 42 wherein the ferrule includes two dissimilar materials and the polishing composition includes at least one soluble material.

47. The method of claim 42 wherein the ferrule material comprises a polymer and the polishing composition comprises an insoluble material selected from the group consisting of alumina, titania, zirconia, and combinations thereof.

48. The method of claim 42 wherein the optical fiber comprises silicon oxide and the polishing composition comprises cerium oxide.

49. The method of claim 42 wherein the ferrule material comprises at least two dissimilar materials and the polishing composition comprises a soluble material selected from the group consisting of oxidizing agents, stopping compounds, alcoholamines, surfactants, film forming agents and combinations thereof.
